(19) United States
(12) Patent Application Publication
(10) Pub. No.: US 2003/0151839 A1
(43) Pub. Date: Aug. 14, 2003

(54) Magnetic disk drive

(75) Inventors: Makoto Ikuma, Osaka (JP); Yasuhiro Enomoto, Osaka (JP); Atsushi Chigira, Kyoto (JP)

Correspondence Address: NIXON PEABODY, LLP, 8180 GREENSBORO DRIVE, SUITE 800, MCLEAN, VA, 22102, US

(73) Assignee: Matsushita Electric Industrial Co., Ltd., Osaka (JP)

(21) Appl. No.: 10/320,416

(22) Filed: Dec. 17, 2002

(30) Foreign Application Priority Data
Dec. 18, 2001 (JP) 2001-385040

(51) Int. Cl. G11B 5/09; G11B 5/02

(52) U.S. Cl. 360/46; 360/67

(57) ABSTRACT

In a magnetic disk drive, overshoot caused in reversing the flowing direction of a recording current flowing through a magnetic head is intensified. The magnetic disk drive includes first and second differential pulse generation units for respectively generating first and second differential pulse signals by differentiating first and second recording signals; and first and second transistors that are provided in parallel to a resistor disposed between ground and an H bridge circuit for driving the magnetic head and are respectively turned on in accordance with the first and second differential pulse signals. When the flowing direction of the recording current is reversed in response to the first and second recording signals, one of the first and second differential pulse signals is generated, and hence, one of the first and second transistors is temporarily turned on. As a result, the overshoot of the recording current is intensified.

### BACKGROUND OF THE INVENTION

The present invention relates to information recording technique for a magnetic disk drive, and more particularly, it relates to technique to control the magnitude of overshoot of a recording current flowing through a recording head.

In a magnetic disk drive, such as a hard disk drive (also designated as an HDD), that is peripheral equipment of a computer, digital information is magnetically recorded on a magnetic recording medium (also designated as a medium). Recently, a GMR (Giant Magneto Resistance) head is generally used for reproducing information recorded in a medium and a recording head including an inductive coil is generally used for recording information.

The recording head forms a magnetic field in accordance with a direction of a recording current flowing through the inductive coil. This magnetic field determines the direction of flux reversal on a medium, so that digital information can be written and recorded on the medium.

FIG. 6 shows the configuration of a recording current driver circuit 1 included in a conventional general magnetic disk drive. In the conventional magnetic disk drive, an H bridge circuit 11 including bipolar transistors Q1, Q2, Q3 and Q4 controls the quantity and the flowing direction of a recording current IL flowing from a VCC terminal to a GND terminal through a recording head (coil L1) and a resistor R1 connected to each other through head contacts HD1 and HD2. This control is performed on the basis of a recording signal DT1 supplied to a recording signal input terminal WD and a recording signal DT2, in a reverse phase to the recording signal DT1, supplied to a recording signal input terminal WDN.

The transistors Q3 and Q4 disposed at an upper stage of the H bridge circuit 11 are respectively driven in accordance with the recording signals DT1 and DT2 for controlling the flowing direction of the recording current IL. On the other hand, the transistors Q1 and Q2 disposed at a lower stage of the H bridge circuit 11 are bias controlled and driven by a circuit including a constant voltage supply VREF, resistors R1 and R2 and MOS transistors M1, M2, M3 and M4 for controlling the quantity of the recording current IL.

The MOS transistor M1 applies, on the basis of the recording signal DT2, a bias voltage determined by the constant voltage supply VREF and the resistor R2 to the transistor Q1. The MOS transistor M3 sets, on the basis of the recording signal DT1, the bias voltage applied to the transistor Q1 to GND level. Similarly, the MOS transistor M2 applies, on the basis of the recording signal DT1, a bias voltage determined by the constant voltage supply VREF and the resistor R2 to the transistor Q2. The MOS transistor M4 sets, on the basis of the recording signal DT2, the bias voltage applied to the transistor Q2 to GND level.

The quantity of the recording current IL is controlled through the above-described bias control. Specifically, as the resistor R1 has a smaller resistance value, the quantity of the recording current IL is larger. In other words, as a current I3 flowing through the resistor R1 is larger, the quantity of the recording current IL is larger. Also, as the voltage of the constant voltage supply VREF is larger, the quantity of the recording current IL is larger.

Now, the recording current flowing through the magnetic head in the conventional magnetic disk drive having the above-described configuration will be described with reference to a timing chart of FIG. 7.

FIG. 7-(A) shows the recording signal DT1, FIG. 7-(B) shows the recording signal DT2 and FIG. 7-(C) shows the recording current IL flowing through the coil L1. It is herein assumed that the direction from the head contact HD1 to the head contact HD2 is a positive direction of the recording current IL (see FIG. 6).

When the recording signal DT1 is at “H” level, the transistors Q3 and Q2 are turned on, and hence, a recording current I1 flows from the VCC terminal through the transistor Q3, the coil L1 (in the positive direction), the transistor Q2 and the resistor R1 toward the GND terminal in the recording current driver circuit 1. When the recording signal DT1 undergoes a “H” to “L” transition and the recording signal DT2 undergoes a “L” to “H” transition in reverse, the transistors Q3 and Q2 are turned off, and the transistors Q4 and Q1 are turned on instead. Therefore, a recording current I2 flows from the VCC terminal through the transistor Q4, the coil L1 (in the negative direction), the transistor Q1 and the resistor R1 toward the GND terminal in the recording current driver circuit 1. Since the flowing direction of the recording current through the coil L1 is thus reversed in accordance with the recording signals DT1 and DT2, the digital information corresponding to the recording signals DT1 and DT2 can be recorded on a medium.

The reliability of the magnetic disk drive largely depends upon the reliability in recording and reproducing information in and from a medium. Since the recording densities of media are recently remarkably increased, it is necessary to improve the reliability by further lowering a bit error rate in recording/reproducing. One of the most significant points for improving the reliability in recording relates to overshoot of a recording current.

In FIG. 7-(C), the recording current IL flowing through the coil L1 is increased to a value exceeding a steady value the moment when the flowing direction through the coil L1 is reversed and becomes stable at the steady value after a short time. This portion exceeding the steady value corresponds to overshoot (shown as a portion A in FIG. 7-(C)). A strong magnetic field can be temporarily formed in the coil L1 by sharply increasing the overshoot and sharply restoring it to the steady state. Thus, a medium can be magnetized in a short time in accordance with the magnetic field formed by the coil L1, so that information can be recorded at a high rate.

The overshoot can be qualitatively presumed to be caused by resonance and oscillation between the coil L1 and various parasitic capacitance and parasitic resistance connected to the coil L1. The coil L1 is accompanied by, for example, the parasitic resistance and capacitance of the coil L1 itself, parasitic inductance of a wire used for connecting a lead frame and a chip, parasitic capacitance of a pad for the head contacts HD1 and HD2, parasitic capacitance and inductance of aluminum wires used in the chip and the parasitic capacitance of the transistors Q1 through Q4 included in the recording current driver circuit 1. In particular, each of the transistors Q1 through Q4 is designed to have a large transistor size (such as a gate width and a device area) for attaining ability to allow a large recording current IL to flow therethrough, and hence has very large parasitic capacitance.

Since the coil L1 is thus complicatedly accompanied by various parasitic elements, it is complicated to quantitatively represent the overshoot by using an accurate expression. Therefore, it is generally difficult to control the magnitude of the overshoot.

In order to solve this problem, an H bridge coil driver circuit has been conventionally improved. FIG. 8 shows the circuit configuration of the conventionally improved H bridge coil driver circuit. In the H bridge coil driver circuit 20, the gates of MOS transistors 13 and 15, which respectively correspond to the transistors Q1 and Q2, are provided with boost capacitor circuits 40 and 41, respectively, so that the voltages of these gates can be temporarily increased respectively when recording signals S1 and S2 are at a low potential level. As a result, the overshoot of the recording current can be temporarily increased when the magnetization of the magnetic head is reversed.

Alternatively, another improvement has been made. FIG. 9 shows the circuit configuration of another conventional improved H bridge coil driver circuit. The H bridge coil driver circuit 45 includes MOS transistors 60 and 62 respectively disposed in parallel to MOS transistors 47 and 49, which respectively correspond to the transistors Q1 and Q2. Boost capacitors are respectively provided between the gates of these MOS transistors 47, 49, 60 and 62 and recording signal input terminals VCDI and /VCDI. When each of recording signals VCDI and /VCDI is at a low potential level, the parallel two MOS transistors are simultaneously placed in an on state, so that the overshoot of the recording current can be temporarily increased.

In the conventional magnetic disk drive, the minimum time interval between a leading (or trailing) edge and a trailing (or leading) edge of the recording current IL is approximately several ns., and each of a rise time and a decay time is as short as 1 ns. or less. Accordingly, the overshoot should be completed in a very short time of approximately several hundreds ps. The frequency of a recording signal used in a magnetic disk drive is increasing year by year, and therefore, it is necessary to control the overshoot in a shorter time in the future. In other words, faster overshoot control is necessary.

In the H bridge coil driver circuit, the overshoot can be temporarily increased without fail. In the H bridge coil driver circuit of FIG. 8, however, when the boost capacitor circuits 40 and 41 alone are provided, the time constant used for the overshoot control cannot be made constant but varies, and therefore, a rather large operation margin should be set. Accordingly, there is a limit in the fast overshoot control attained by using this circuit.

Furthermore, in the H bridge coil driver circuit of FIG. 9, since the MOS transistors 47 and 60 and the MOS transistors 49 and 62 are provided in parallel respectively, the parasitic capacitance connected to a magnetic head 50 is increased, which can be a factor to prevent a fast switching operation. Accordingly, there is also a limit in the fast overshoot control attained by using this circuit.

### SUMMARY OF THE INVENTION

In consideration of the aforementioned conventional problems, an object of the invention is providing a magnetic disk drive that can control overshoot of a recording current flowing through a magnetic head so as to sharply increase and sharply restore it to a steady state and that can exhibit a better high frequency characteristic.

Means of this invention for overcoming the problems is providing a magnetic disk drive, which includes an H bridge circuit including a magnetic head connected between a pair of junction points where transistors are serially connected, a flowing direction of a recording current flowing through the magnetic head being controlled by switching the transistors of the H bridge circuit in accordance with a first recording signal and a second recording signal of a reverse phase to the first recording signal, with a resistive element provided between the H bridge circuit and ground for controlling a quantity of the recording current; and an overshoot controller for controlling a magnitude of overshoot of the recording current caused in reversing the flowing direction of the recording current. The overshoot controller includes a first differential pulse generation unit for generating a first differential pulse signal by differentiating the first recording signal; a second differential pulse generation unit for generating a second differential pulse signal by differentiating the second recording signal; a first transistor that is provided in parallel to the resistive element, receives the first differential pulse signal generated by the first differential pulse generation unit and is turned on when the first differential pulse signal exceeds a given threshold voltage; and a second transistor that is provided in parallel to the resistive element, receives the second differential pulse signal generated by the second differential pulse generation unit and is turned on when the second differential pulse signal exceeds a given threshold voltage.

According to the invention, the first and second differential pulse signals are respectively generated by the first and second differential pulse generation units and supplied to the first and second transistors. The first and second transistors are turned on respectively when each of the first and the second differential pulse signals exceeds a given threshold value. Both of the first and second transistors are provided in parallel to the resistive element for controlling the quantity of the recording current, and therefore, when each of the first and second transistors is turned on, the resistance value between the H bridge circuit and the ground is reduced, so as to increase the quantity of the recording current. The first and second differential pulse signals used in control for respectively turning on the first and second transistors are generated when the first and second recording signals are supplied to the magnetic disk drive, respectively, namely, in a transition period when the conducting polarity of the magnetic head is reversed. Accordingly, the quantity of the recording current is temporarily increased in this transition period, so that the overshoot of the recording current can be intensified. As a result, the recording current substantially used for magnetizing a medium is increased so as to strengthen the magnetic field for information recording, and hence, recording can be performed at a higher rate.

Furthermore, according to the invention, since the first and second transistors are inserted between the H bridge circuit and the ground, parasitic capacitance connected to the magnetic head is smaller than when these transistors are provided in parallel to transistors included in the H bridge circuit, and hence, harmful influence to cause the operation delay of the transistors derived from the parasitic capacitance can be avoided. Accordingly, the high frequency characteristic of the magnetic disk drive can be improved.

Another means of this invention for overcoming the problems is providing a magnetic disk drive, which includes an H bridge circuit including a magnetic head connected between a pair of junction points where transistors are serially connected, a flowing direction of a recording current flowing through the magnetic head being controlled by switching the transistors of the H bridge circuit in accordance with a first recording signal and a second recording signal of a reverse phase to the first recording signal, with a resistive element provided between the H bridge circuit and ground for controlling a quantity of the recording current; a constant voltage supply for generating a given bias voltage; and an overshoot controller for controlling a magnitude of overshoot of the recording current caused in reversing the flowing direction of the recording current. The overshoot controller includes a first capacitive element provided between a first recording signal input terminal and a base or a gate of a first transistor that is one of the transistors of the H bridge circuit for controlling the quantity of the recording current and is turned on in accordance with the first recording signal; a second capacitive element provided between a second recording signal input terminal and a base or a gate of a second transistor that another of the transistors of the H bridge circuit for controlling the quantity of the recording current and is turned on in accordance with the second recording signal; a second resistive element for applying the given bias voltage generated by the constant voltage supply to the base or the gate of each of the first and second transistors; a third transistor that is connected between the second resistive element and the base or the gate of the first transistor and is turned on in accordance with the first recording signal; and a fourth transistor that is connected between the second resistive element and the base or the gate of the second transistor and is turned on in accordance with the second recording signal, and the first and second capacitive elements share the second resistive element and alternately construct first and second differential pulse generation units by switching the third and fourth transistors.

According to this invention, the first and second differential pulse generation units each constructed from the first or second capacitive element and the second resistive element differentiates the first or second recording signal, and the resultant differential voltage is superposed upon the bias voltage for the first or second transistor. Therefore, the quantity of the recording current is temporarily increased in a transition period when the conducting polarity of the magnetic head is reversed, and hence, the overshoot of the recording current is intensified. Accordingly, since the recording current substantially used for magnetizing a medium is increased so as to strengthen the magnetic field for information recording, recording can be performed at a higher rate.

Furthermore, according to this invention, since the first and second differential pulse generation units share one resistive element (second resistive element), the time constants of these units can be easily adjusted to an equivalent level. Therefore, variation in differential voltages respectively superposed upon the bias voltages supplied to the first and second transistors can be suppressed, so that the operation margin of the H bridge circuit can be smaller. As a result, the high frequency characteristic of the magnetic disk drive can be improved.

### BRIEF DESCRIPTION OF THE DRAWINGS

FIG. 1 is a diagram for showing the configuration of a magnetic disk drive according to Embodiment 1 of the invention.

FIG. 2 is a timing chart for showing the operation of the magnetic disk drive of FIG. 1.

FIG. 3 is a diagram for showing the configuration of a magnetic disk drive according to Embodiment 2 of the invention.

FIG. 4 is a diagram for showing the configuration of differential pulse generation units included in the magnetic disk drive of FIG. 3.

FIG. 5 is a timing chart for showing the operation of the magnetic disk drive of FIG. 3.

FIG. 6 is a diagram for showing the configuration of a conventional magnetic disk drive.

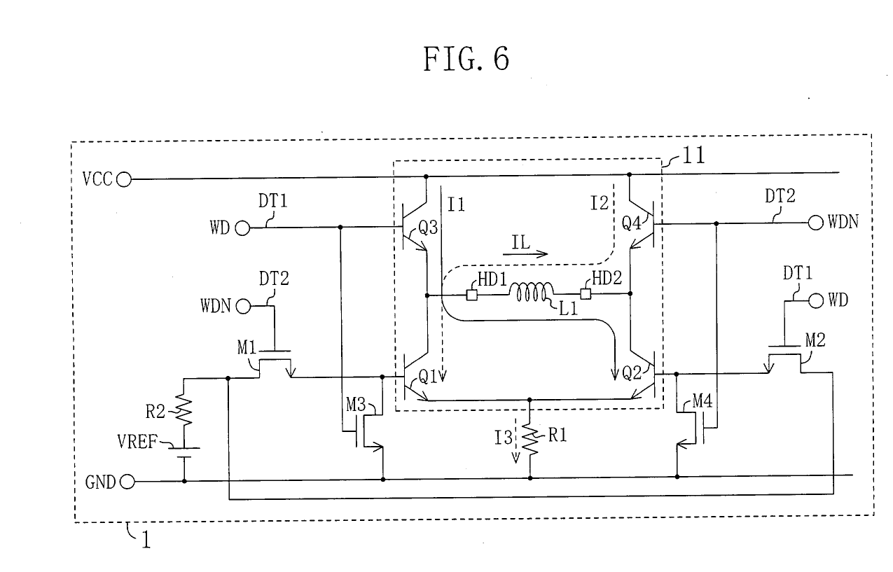

FIG. 7 is a timing chart for showing the operation of the magnetic disk drive of FIG. 6.

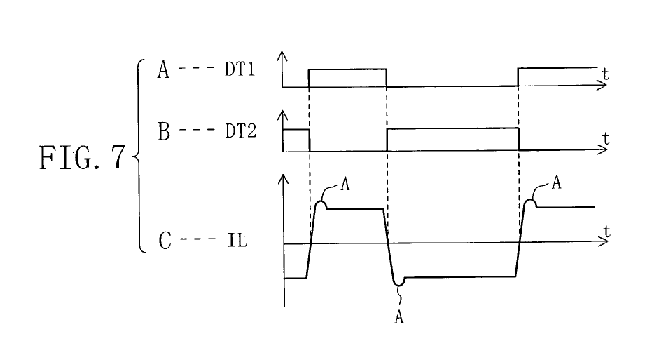

FIG. 8 is a circuit diagram of a conventional improved H bridge coil driver circuit.

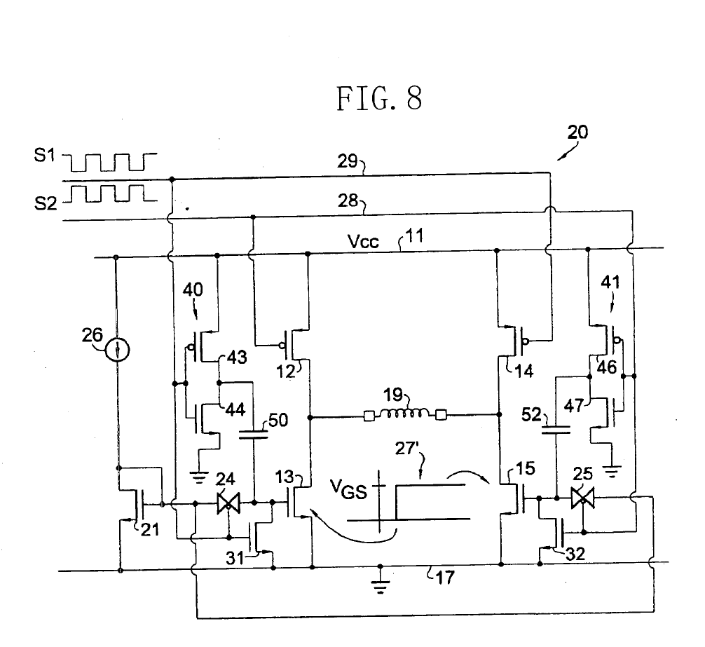

FIG. 9 is a circuit diagram of another conventional improved H bridge coil driver circuit.

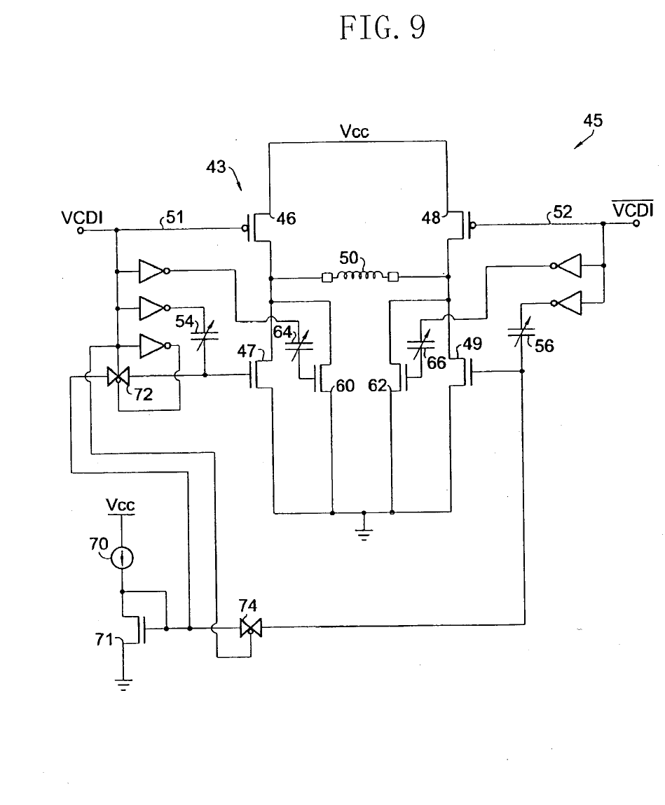

### DETAILED DESCRIPTION OF THE INVENTION

Preferred embodiments of the invention will now be described with reference to the accompanying drawings.

(Embodiment 1)

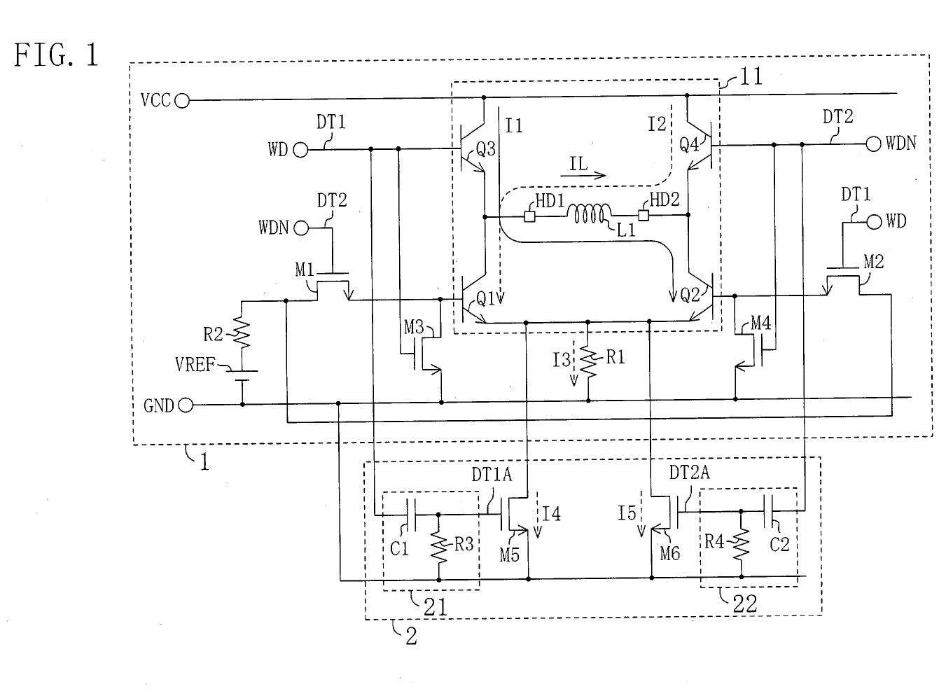

FIG. 1 shows a recording current driver circuit 1 and an overshoot controller 2 included in a magnetic disk drive according to Embodiment 1 of the invention. The recording current driver circuit 1 of this embodiment has a configuration similar to that of a conventional driver circuit and hence the description is omitted, and the overshoot controller 2 will now be described.

The overshoot controller 2 includes differential pulse generation units 21 and 22 (respectively corresponding to first and second differential pulse generation units of this invention) and MOS transistors M5 and M6 (respectively corresponding to first and second transistors of this invention). The source of the MOS transistor M5 is connected to a GND terminal, and the drain thereof is connected to the emitters of transistors Q1 and Q2 disposed at the lower stage of an H bridge circuit 11. In other words, the source and the drain of the MOS transistor M5 are connected in parallel to a resistor R1 (corresponding to a resistive element of this invention). Similarly, the source and the drain of the MOS transistor M6 are connected in parallel to the resistor R1.

A capacitor C1 and a resistor R3 included in the differential pulse generation unit 21 are connected to the gate of the MOS transistor M5. The other end of the capacitor C1 is connected to a recording signal input terminal WD, and the other end of the resistor R3 is connected to the GND terminal. In other words, the differential pulse generation unit 21 is a differential circuit for differentiating a recording signal DT1 (corresponding to a first recording signal of this invention) so as to generate a differential pulse signal DT1A (corresponding to a first differential pulse signal of this invention). The resistor R3 is a polysilicon resistor.

A capacitor C2 and a resistor R4 included in the differential pulse generation unit 22 are connected to the gate of the MOS transistor M6. The other end of the capacitor C2 is connected to a recording signal input terminal WDN and the other end of the resistor R4 is connected to the GND terminal. In other words, the differential pulse generation unit 22 is a differential circuit for differentiating a recording signal DT2 (corresponding to a second recording signal of this invention) so as to generate a differential pulse signal DT2A (corresponding to a second differential pulse signal of this invention). The resistor R4 is a polysilicon resistor.

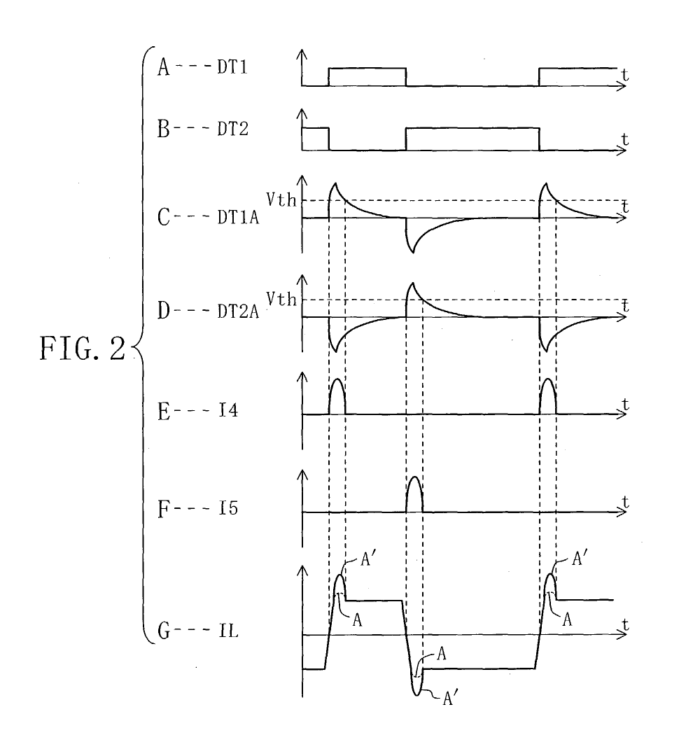

Now, the operation of the magnetic disk drive including the overshoot controller 2 having the aforementioned configuration will be described with reference to a timing chart of FIG. 2.

The recording signal DT1 (shown in FIG. 2-(A)) is differentiated by the differential pulse generation unit 21, so as to be changed into a differential pulse in which each of a leading edge and a trailing edge is intensified during a given time. This differential pulse is output as the differential pulse signal DT1A to the gate of the MOS transistor M5 (shown in FIG. 2-(C)). When the recording signal DT1 undergoes a “L” to “H” transition and the differential pulse signal DT1A exceeds a predetermined threshold value Vth, the gate of the MOS transistor M5 is turned on, so that a differential current I4 (see FIG. 1) can flow from its drain to its source (shown in FIG. 2-(E)).

In a period when the recording signal DT1 is at “H” level, a recording current I1 flows from a VCC terminal through a transistor Q3, a coil L1 (in the positive direction), the transistor Q2 and the resistor R1 toward the GND terminal. As described above, the source and the drain of the MOS transistor M5 are connected in parallel to the resistor R1, and hence, the recording current I1 corresponds to a sum of a current I3 and the differential current I4. Accordingly, the gate of the MOS transistor M5 is turned on and the differential current I4 flows in a large quantity between the drain and the source thereof. As a result, the recording current I1 is increased, so that the overshoot can be intensified (as shown as a portion A′ on the positive polarity side of FIG. 2-(G)) as compared with conventional overshoot (shown as a portion A on the positive polarity side of FIG. 2-(G)).

With respect to the recording signal DT2 (shown in FIG. 2-(B)), a similar operation is performed. The recording signal DT2 is differentiated by the differential pulse generation unit 22, so as to be changed into a differential pulse in which each of a leading edge and a trailing edge is intensified during a given time. This differential pulse is output as the differential pulse signal DT2A to the gate of the MOS transistor M6 (shown in FIG. 2-(D)). When the recording signal DT2 undergoes a “L” to “H” transition and the differential pulse signal DT2A exceeds the predetermined threshold value Vth, the gate of the MOS transistor M6 is turned on, so that a differential current I5 (see FIG. 1) can flow from its drain to its source (shown in FIG. 2-(F)).

In a period when the recording signal DT2 is at “H” level, a recording current I2 flows from the VCC terminal through a transistor Q4, the coil L1 (in the negative direction), the transistor Q1 and the resistor R1 toward the GND terminal. As described above, the source and the drain of the MOS transistor M6 are connected in parallel to the resistor R1, and hence, the recording current I2 corresponds to a sum of a current I3 and the differential current I5. Accordingly, the gate of the MOS transistor M6 is turned on and the differential current I5 flows in a large quantity between the drain and the source thereof. As a result, the recording current I2 is increased, so that the overshoot can be intensified (as shown as a portion A′ on the negative polarity side in FIG. 2-(G)) as compared with the conventional overshoot (shown as a portion A on the negative polarity side in FIG. 2-(G)).

It is mutual conductance gm determining the magnitude of the drain current according to the gate voltage of the MOS transistor M5 or M6 that determines the magnitude of the overshoot. The mutual conductance gm can be adjusted by changing the gate width of the MOS transistor M5 or M6. Therefore, the period and the magnitude of the overshoot can be easily adjusted. Also, the magnitude of the overshoot can be adjusted by controlling the capacitor C1 or C2 and the resistor R3 or R4.

In this manner, according to this embodiment, the generation period of the overshoot of the recording current IL flowing through the coil L1 is controlled by the overshoot controller 2, so as to increase the magnitude of the overshoot. As a result, the reliability in recording information of the magnetic disk drive can be improved.

Also, since the MOS transistors M5 and M6 are provided in series to the H bridge circuit 11, the parasitic capacitance of the MOS transistors M5 and M6 is serially connected to the parasitic capacitance of the transistors Q1 and Q2 included in the H bridge circuit 11. Accordingly, even though the MOS transistors M5 and M6 are provided, the parasitic capacitance between the magnetic head L1 and the ground can be prevented from largely increasing. In other words, the overshoot of the recording current IL can be intensified on the basis of the differential pulse signals DT1A and DT2A without spoiling the high frequency characteristic of the magnetic disk drive.

Although each of the differential pulse generation units 21 and 22 includes the resistor R3 or R4 and the capacitor C1 or C2 in this embodiment, each differential pulse generation unit may employ another configuration as far as a pulse can be generated during a given time. Also, the overshoot controller 2 may include, instead of the MOS transistors M5 and M6, bipolar transistors capable of exhibiting a similar effect. Furthermore, although the transistors Q1 through Q4 are bipolar transistors in this embodiment, they may be MOS transistors or the like.

(Embodiment 2)

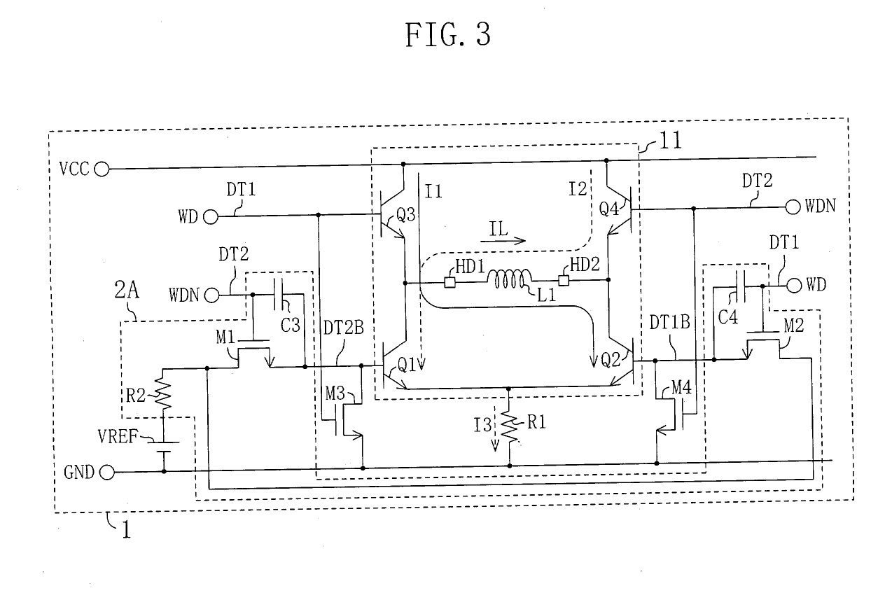

FIG. 3 shows a recording current driver circuit 1 and an overshoot controller 2A included in a magnetic disk drive according to Embodiment 2 of the invention. The recording current driver circuit 1 of this embodiment has a similar configuration to the conventional driver circuit and hence the description is omitted, and the overshoot controller 2A will be described.

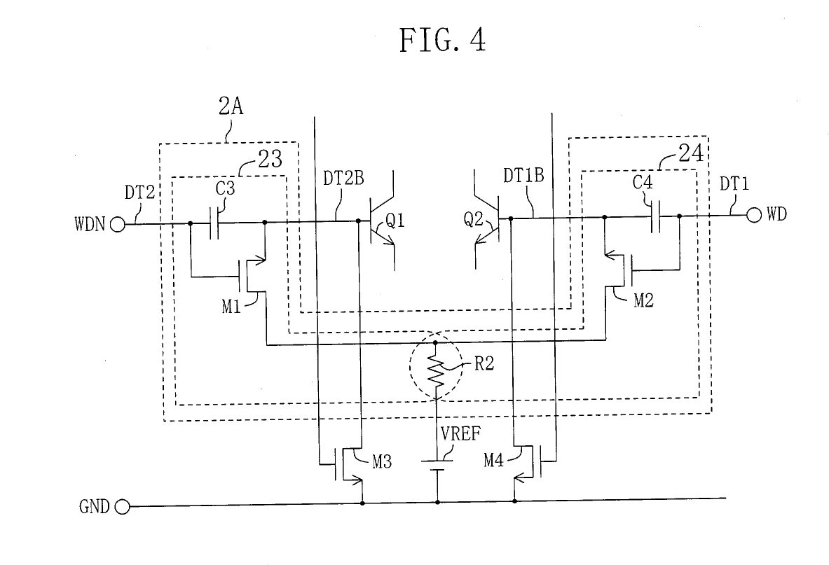

The overshoot controller 2A includes differential pulse generation unites 23 and 24 (respectively corresponding to second and first differential pulse generation units of this invention) and a resistor R2 (corresponding to a second resistive element of this invention). FIG. 4 shows the configuration of the differential pulse generation units 23 and 24 of this embodiment. This drawing is extracted from FIG. 3.

The differential pulse generation unit 23 is constructed from a capacitor C3 (corresponding to a second capacitive element of this invention), a MOS transistor M1 (corresponding to a fourth transistor of this invention) included in the recording current driver circuit 1 and the resistor R2. The capacitor C3 is connected in parallel between the gate and the source of the MOS transistor M1, namely, is connected between a transistor Q1 (corresponding to a second transistor of this invention) included in an H bridge circuit 11 and a recording signal input terminal WDN (corresponding to a second recording signal input terminal of this invention). When the MOS transistor M1 is in an on state, the differential pulse generation unit 23 works as a differential circuit. The resistor R2 is a polysilicon resistor.

Similarly, the differential pulse generation unit 24 is constructed from a capacitor C4 (corresponding to a first capacitive element of this invention), a MOS transistor M2 (corresponding to a third transistor of this invention) included in the recording current driver circuit 1 and the resistor R2. The capacitor C4 is connected in parallel between the gate and the source of the MOS transistor M2, namely, is connected between a transistor Q2 (corresponding to a first transistor of this invention) included in the H bridge circuit 11 and a recording signal input terminal WD (corresponding to a first recording signal input terminal of this invention). When the MOS transistor M2 is in an on state, the differential pulse generation unit 24 works as a differential circuit.

In general, in a bipolar transistor, there is a delay from a bias voltage turning off to a collector current turning off because of charge stored in its base when it is in an on state. In order to reduce the delay, it is necessary to discharge the charge stored in the base. The capacitor C3 (or C4) of this embodiment also functions as a speed-up capacitor for discharging the charge stored in the base of the transistor Q1 (or Q2), so as to increase the switching rate of the transistor Q1 (or Q2).

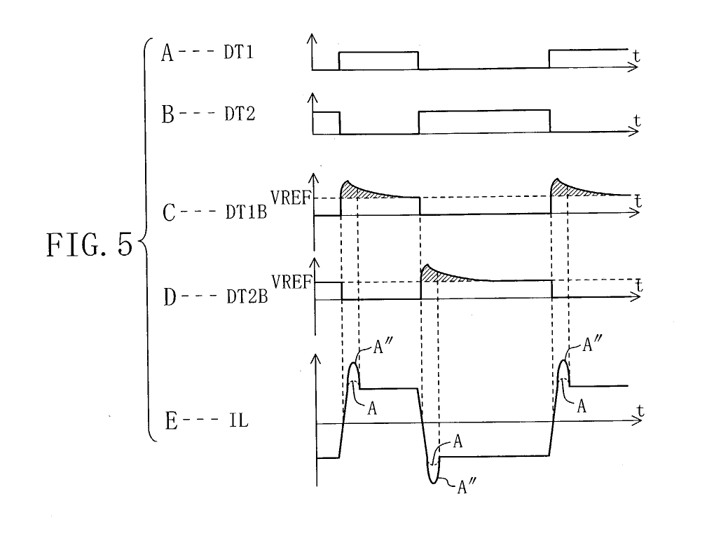

The operation of the magnetic disk drive including the overshoot controller 2A having the aforementioned configuration will now be described with reference to a timing chart of FIG. 5.

In a period when a recording signal DT1 (shown in FIG. 5-(A)) is at “H” level, a recording current I1 flows from a VCC terminal through a transistor Q3, a coil L1 (in the positive direction), the transistor Q2 and a resistor R1 toward a GND terminal. The recording signal DT1 is differentiated by the differential pulse generation unit 24, so as to be changed into a differential pulse in which potential in the vicinity of a leading edge is raised during a given time. This differential pulse is superposed upon a bias voltage supplied by a constant voltage supply VREF to change into a synthesized pulse signal DT1B, which is applied to the base of the transistor Q2 (shown in FIG. 5-(C)). In FIG. 5-(C), a hatched portion corresponds to the superposed differential pulse.

In a period when the differential pulse is generated, the bias voltage applied to the transistor Q2 is temporarily increased, so as to increase the emitter current. Furthermore, the charge stored in the base of the transistor Q1 is rapidly discharged through the capacitor C3, and hence, the transistor Q1 is rapidly turned off. Since the transistor Q1 is thus rapidly turned off so as to avoid simultaneously placing the transistors Q1 and Q2 in an on state, the rate of increasing the emitter current of the transistor Q2 can be increased. Accordingly, the increase of the emitter current of the transistor Q2 leads to increase of the recording current I1, so that overshoot (shown as a portion A″ on the positive polarity side in FIG. 5-(E)) can be intensified as compared with the conventional overshoot (shown as a portion A on the positive polarity side in FIG. 5-(E)).

With respect to a recording signal DT2, a similar operation is performed. In a period when the recording signal DT2 (shown in FIG. 5-(B)) is at “H” level, a recording current I2 flows from the VCC terminal through a transistor Q4, the coil L1 (in the negative direction), the transistor Q1 and the resistor R1 toward the GND terminal. The recording signal DT2 is differentiated by the differential pulse generation unit 23 so as to be changed into a differential pulse in which potential in the vicinity of a leading edge is raised during a given time. This differential pulse is superposed upon the bias voltage supplied by the constant voltage supply VREF so as to change into a synthesized pulse signal DT2B, which is applied to the base of the transistor Q1 (shown in FIG. 5-(D)). In FIG. 5-(D), a hatched portion corresponds to the superposed differential pulse.

In a period when the differential pulse is generated, the bias voltage applied to the transistor Q1 is temporarily increased, so as to increase the emitter current. Furthermore, since the charge stored in the base of the transistor Q2 is rapidly discharged through the capacitor C4, the transistor Q2 is rapidly turned off. Since the transistor Q2 is thus rapidly turned off so as to avoid simultaneously placing the transistors Q1 and Q2 in an on state, the rate of increasing the emitter current of the transistor Q1 can be increased. Accordingly, the increase of the emitter current of the transistor Q1 leads to increase of the recording current I2, so that the overshoot (shown as a portion A″ on the negative polarity side in FIG. 5-(E)) can be intensified as compared with the conventional overshoot (shown as a portion A on the negative polarity side in FIG. 5-(E)).

The magnitude and the period of the overshoot can be adjusted by changing the capacitors C3 and C4 and the resistor R2.

Also, in the case where the resistor R2 has a small resistance value, another resistive element that is not a resistor, such as internal resistance of the constant voltage supply VREF like emitter resistance of a transistor included in an output circuit part of the constant voltage supply, may be used as the resistor R2. Alternatively, in the case where the resistor R2 has a large resistance value, another resistive element that is a resistor, such as a polysilicon resistor formed on a semiconductor substrate, may be used as the resistor R2.

In this manner, according to this embodiment, the overshoot controller 2A is constructed by additionally providing the capacitors C3 and C4 in the recording current driver circuit 1. This overshoot controller 2A can intensify the overshoot of the recording current IL flowing through the coil L1, so that the reliability in recording information of the magnetic disk drive can be improved.

Furthermore, since the differential pulse generation units 23 and 24 share the resistor R2, their time constants can be easily adjusted to an equivalent level. Therefore, variation in the differential voltage superposed upon the bias voltage applied to the transistor Q1 and Q2 can be suppressed, and hence, the operation margin of the H bridge circuit 11 can be reduced. As a result, the H bridge circuit 11 can be operated in accordance with a recording signal of a higher frequency. In other words, a magnetic disk drive with better high frequency characteristic can be realized.

The devices additionally provided in the recording current driver circuit 1 are not limited to the capacitors C3 and C4 but may be any other element that can generate a pulse during a given period in synchronization with the recording signals DT1 or DT2. Also, although the transistors Q1 through Q4 are bipolar transistors in this embodiment, they may be MOS transistors or the like.

Although the resistors R3 and R4 are polysilicon resistors in the above-described embodiments, the resistors R3 and R4 are not limited to them but may be, for example, a diffused resistor. However, a polysilicon resistor is preferably used because it has small parasitic capacitance and exhibit a better high frequency characteristic.

As described so far, according to the present invention, when a magnetic disk drive records information in a medium, the overshoot of a recording current flowing through a magnetic head can be sharply increased and sharply restored to the steady state, and hence, the magnetic field formed by the magnetic head can be strengthened. Accordingly, recording at a high rate can be performed highly reliably, so that a bit error rate can be lowered. Also, since the magnetic disk drive of this invention can exhibit a better high frequency characteristic than a conventional magnetic disk drive, information can be recorded at a higher data transfer rate.

What is claimed is:

1. A magnetic disk drive comprising:
an H bridge circuit including a magnetic head connected between a pair of junction points where transistors are serially connected, a flowing direction of a recording current flowing through said magnetic head being controlled by switching said transistors of said H bridge circuit in accordance with a first recording signal and a second recording signal of a reverse phase to said first recording signal;
a resistive element provided between said H bridge circuit and ground for controlling a quantity of said recording current; and
an overshoot controller for controlling a magnitude of overshoot of said recording current caused in reversing the flowing direction of said recording current,
wherein said overshoot controller includes:
a first differential pulse generation unit for generating a first differential pulse signal by differentiating said first recording signal;
a second differential pulse generation unit for generating a second differential pulse signal by differentiating said second recording signal;
a first transistor that is provided in parallel to said resistive element, receives said first differential pulse signal generated by said first differential pulse generation unit and is turned on when said first differential pulse signal exceeds a given threshold voltage; and
a second transistor that is provided in parallel to said resistive element, receives said second differential pulse signal generated by said second differential pulse generation unit and is turned on when said second differential pulse signal exceeds a given threshold voltage.

2. The magnetic disk drive of claim 1,
wherein each of said first and second differential pulse generation units is a differential circuit including a capacitive element and a resistive element.

3. The magnetic disk drive of claim 2,
wherein said resistive element included in each of said first and second differential pulse generation units is a polysilicon resistor.

4. A magnetic disk drive comprising:
an H bridge circuit including a magnetic head connected between a pair of junction points where transistors are serially connected, a flowing direction of a recording current flowing through said magnetic head being controlled by switching said transistors of said H bridge circuit in accordance with a first recording signal and a second recording signal of a reverse phase to said first recording signal;
a resistive element provided between said H bridge circuit and ground for controlling a quantity of said recording current;
a constant voltage supply for generating a given bias voltage; and
an overshoot controller for controlling a magnitude of overshoot of said recording current caused in reversing the flowing direction of said recording current,
wherein said overshoot controller includes:
a first capacitive element provided between a first recording signal input terminal and a base or a gate of a first transistor that is one of said transistors of said H bridge circuit for controlling the quantity of said recording current and is turned on in accordance with said first recording signal;
a second capacitive element provided between a second recording signal input terminal and a base or a gate of a second transistor that is another of said transistors of said H bridge circuit for controlling the quantity of said recording current and is turned on in accordance with said second recording signal;
a second resistive element for applying said given bias voltage generated by said constant voltage supply to the base or the gate of each of said first and second transistors;
a third transistor that is connected between said second resistive element and the base or the gate of said first transistor and is turned on in accordance with said first recording signal; and
a fourth transistor that is connected between said second resistive element and the base or the gate of said second transistor and is turned on in accordance with said second recording signal, and
said first and second capacitive elements share said second resistive element and alternately construct first and second differential pulse generation units by switching said third and fourth transistors.
